(19) United States
(12) Patent Application Publication
(10) Pub. No.: US 2026/0127867 A1
(43) Pub. Date: May 7, 2026

(54) LEARNING APPARATUS AND LEARNING METHOD

(71) Applicant: Mitsubishi Electric Corporation, Tokyo (JP)

(72) Inventor: Takuya Matsuda, Tokyo (JP)

(73) Assignee: Mitsubishi Electric Corporation, Tokyo (JP)

(21) Appl. No.: 19/425,199

(22) Filed: Dec. 18, 2025

Related U.S. Application Data
(63) Continuation of application No. PCT/JP2023/027295, filed on Jul. 26, 2023.

(51) Int. Cl. G06V 10/776; G06V 10/40; G06V 10/70; G06V 10/74; G06V 10/774

(52) U.S. Cl. CPC G06V 10/776; G06V 10/40; G06V 10/761; G06V 10/774; G06V 10/87

(57) ABSTRACT

A learning apparatus includes processing circuitry configured to: acquire an inspection-target image dataset; acquire features of executed-task image datasets; extract features of the acquired inspection-target image dataset; calculate degrees of feature similarity; select one or more trained models corresponding to executed-task image datasets whose degrees of feature similarity are high in the executed-task image datasets; generate a new trained model which is a good-product distribution by inputting the acquired inspection-target image dataset to the selected trained models; determine whether precision of the generated new trained model is equal to or higher than a threshold; and output information representing the new trained model on a basis of a result of the determination.

### CROSS REFERENCE TO RELATED APPLICATION

This application is a Continuation of PCT International Application No. PCT/JP2023/027295, filed on Jul. 26, 2023, which is hereby expressly incorporated by reference into the present application.

### TECHNICAL FIELD

The present disclosure relates to a learning apparatus to obtain a trained model and a learning method therefor.

### BACKGROUND ART

In a case where AI automated visual inspection is applied to a product at a production site, it is necessary to collect inspection-target image datasets as training data for implementing a desired function. In view of this, it has conventionally been demanded to implement few-shot learning using past models such as transfer learning.

On the other hand, in a case where there are a plurality of past models, it is necessary to learn and evaluate all the past models, and select the most precise model in order to obtain a model optimum for inspection-target image datasets. Accordingly, in a case where the number of past models is enormous, a huge learning cost is incurred to obtain the optimum model.

In view of this, techniques to select a past model on the basis features of image datasets and the like, and perform transfer learning have been proposed.

For example, examples of the transfer learning technologies described above include a technology disclosed in Patent Literature 1.

This technology adopts a scheme in which a plurality of AI models are combined to increase the precision of inspecting good products and bad products of a product.

In this technology, first, inspection data is input to a plurality of past models, and past models whose intermediate outputs or final outputs are correlated at degrees which are equal to or lower than a certain value are selected. Then, a plurality of hybrid model candidates are created using the selected models. Then, the most precise one is adopted from the hybrid model candidates.

In this manner, in this technology, inspection data is input to a plurality of hybrid models, and learning is performed such that label determination is performed correctly on the basis of the weighted sum of outputs of the respective models.

### CITATION LIST

### Patent Literature

Patent Literature 1: WO 2022/215559

### SUMMARY OF INVENTION

### Technical Problem

As described above, in the existing transfer learning technology, a plurality of pairs of models whose intermediate outputs or final outputs that are obtained when inspection data (inspection-target image datasets) is input to the past models are correlated at low degrees are selected. In this case, the models are independent of each other, but there is a possibility that models appropriate for the inspection data cannot be selected.

The present disclosure has been made to solve the problem described above, and an object thereof is to provide a learning apparatus that makes it possible to obtain a trained model appropriate for an inspection-target image dataset as compared to conventional techniques.

### Solution to Problem

A learning apparatus according to the present disclosure includes: processing circuitry configured to: acquire an inspection-target image dataset; acquire features of executed-task image datasets, the features being based on outputs from a plurality of intermediate layers in trained models corresponding to the executed-task image datasets; extract features of the acquired inspection-target image dataset a basis of the trained models corresponding to the executed-task image datasets and the inspection-target image dataset, the features being based on outputs from the plurality of intermediate layers in the trained models; calculate degrees of feature similarity on a basis of the features of the extracted inspection-target image dataset and the features of the executed-task image datasets having been acquired; select, on a basis of the degrees of feature similarity having been calculated, one or more trained models corresponding to executed-task image datasets whose degrees of feature similarity to the acquired inspection-target image dataset are high in the executed-task image datasets; generate a new trained model which is a good-product distribution by inputting the acquired inspection-target image dataset to the selected trained models on a basis of the acquired inspection-target image dataset and the selected trained models; determine whether precision of the generated new trained model is equal to or higher than a threshold on a basis of the generated new trained model; and output information representing the new trained model determined as having precision which is equal to or greater than the threshold on a basis of a result of the determination.

### Advantageous Effects of Invention

Since the present disclosure adopts the configuration described above, it becomes possible to obtain a trained model appropriate for an inspection-target image dataset as compared to conventional techniques.

### BRIEF DESCRIPTION OF DRAWINGS

FIG. 1 is a block diagram illustrating a configuration example of a learning system according to a first embodiment.

FIG. 2 is a block diagram illustrating a configuration example of a learning apparatus according to the first embodiment.

FIG. 3 is a flowchart illustrating an operation example of the learning apparatus according to the first embodiment.

FIG. 4 is a drawing illustrating an overview of an overall operation performed by the learning apparatus according to the first embodiment.

FIG. 5 is a drawing illustrating an overview of an operation performed by the learning apparatus according to the first embodiment.

FIG. 6 is a drawing illustrating an overview of an operation performed by the learning apparatus according to the first embodiment.

FIG. 7 is a drawing illustrating an overview of an operation performed by the learning apparatus according to the first embodiment.

FIG. 8 is a drawing illustrating an overview of an operation performed by the learning apparatus according to the first embodiment.

FIG. 9 is a block diagram illustrating a configuration example of a learning apparatus according to a second embodiment.

FIG. 10 is a flowchart illustrating an operation example of the learning apparatus according to the second embodiment.

FIG. 11 is a drawing illustrating an overview of an operation performed by the learning apparatus according to the second embodiment.

FIG. 12 is a drawing illustrating an overview of an operation performed by the learning apparatus according to the second embodiment.

FIG. 13 is a drawing illustrating an overview of an operation performed by the learning apparatus according to the second embodiment.

FIGS. 14A and 14B are block diagrams illustrating hardware configuration examples of the learning apparatuses according to the first and second embodiments.

### DESCRIPTION OF EMBODIMENTS

Hereinafter, embodiments are explained in detail with reference to the drawings.

### First Embodiment

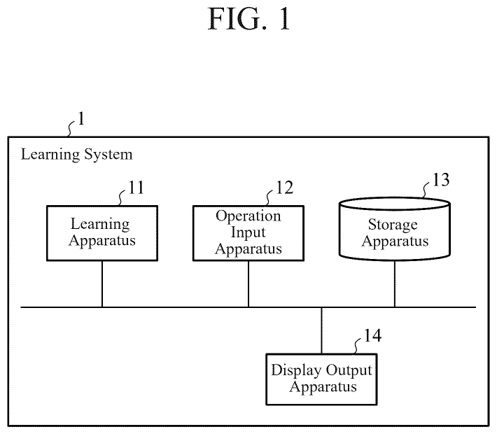

FIG. 1 is a diagram illustrating a configuration example of a learning system 1 according to a first embodiment.

As illustrated in FIG. 1, the learning system 1 includes a learning apparatus 11, an operation input apparatus 12, a storage apparatus 13, and a display output apparatus 14.

The learning apparatus 11 outputs information representing a new trained model on the basis of an inspection-target image dataset input via the operation input apparatus 12, and features of executed-task image datasets represented by information stored on the storage apparatus 13 and trained models corresponding to the executed-task image datasets.

A configuration example of the learning apparatus 11 is mentioned later.

The operation input apparatus 12 is an apparatus that accepts operation by a user.

For example, the operation input apparatus 12 outputs, to the learning apparatus 11, the inspection-target image dataset input by the user.

The storage apparatus 13 stores various types of data to be handled in the learning system 1. For example, the storage apparatus 13 stores the information representing features of executed-task image datasets and trained models corresponding to the executed-task image datasets.

Here, for example, the storage apparatus 13 is a non-volatile or volatile semiconductor memory such as a Random Access Memory (RAM), a Read Only Memory (ROM), a flash memory, an Erasable Programmable ROM (EPROM), or an Electrically EPROM (EEPROM), a magnetic disk, a flexible disc, an optical disc, a compact disc, a mini disc, a Digital Versatile Disc (DVD), or the like.

The display output apparatus 14 displays the information representing the new trained model output by the learning apparatus 11.

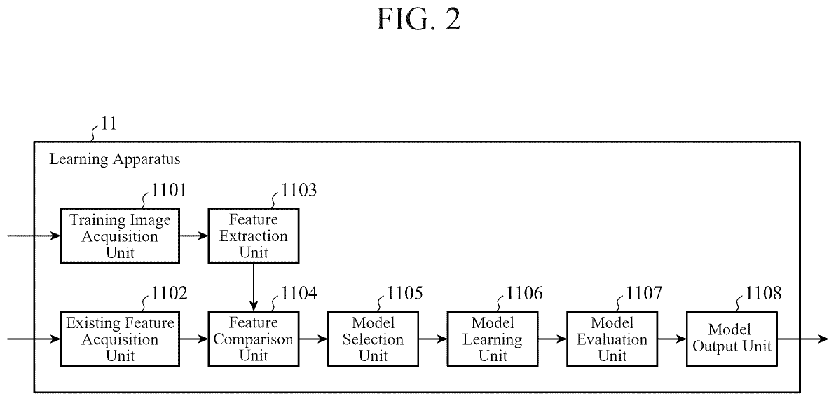

Next, a configuration example of the learning apparatus 11 is explained with reference to FIG. 2.

As illustrated in FIG. 2, the learning apparatus 11 includes a training image acquisition unit 1101, an existing feature acquisition unit 1102, a feature extraction unit 1103, a feature comparison unit 1104 a model selection unit 1105, a model learning unit 1106, a model evaluation unit 1107, and a model output unit 1108.

The training image acquisition unit 1101 acquires the inspection-target image dataset. At this time, the training image acquisition unit 1101 acquires an inspection-target image dataset input via the operation input apparatus 12.

The existing feature acquisition unit 1102 acquires features of executed-task image datasets. At this time, the existing feature acquisition unit 1102 acquires the features of the executed-task image datasets represented by the information stored on the storage apparatus 13. In addition, the features of the executed-task image datasets acquired by the existing feature acquisition unit 1102 are features based on outputs from a plurality of intermediate layers in the trained models corresponding to the executed-task image datasets.

The feature extraction unit 1103 extracts features of the inspection-target image dataset acquired by the training image acquisition unit 1101 on the basis of the trained models corresponding to the executed-task image datasets and the inspection-target image dataset. The features of the inspection-target image dataset extracted by the feature extraction unit 1103 are features based on outputs from the plurality of intermediate layers in the trained models.

At this time, for example, the feature extraction unit 1103 may extract, as features, outputs from the plurality of intermediate layers that are obtained when the inspection-target image dataset or a good-product image dataset in the inspection-target image dataset is input to the trained models corresponding to the executed-task image datasets.

In addition, for example, the feature extraction unit 1103 may extract, as features, vector groups obtained by averaging, channel by channel, outputs from the plurality of intermediate layers obtained when the inspection-target image dataset or a good-product image dataset in the inspection-target image dataset is input to the trained models corresponding to the executed-task image datasets.

In addition, for example, the feature extraction unit 1103 may extract, as features, vectors obtained by averaging the overall outputs from the plurality of intermediate layers obtained when the inspection-target image dataset or a good-product image dataset in the inspection-target image dataset is input to the trained models corresponding to the executed-task image datasets.

Note that, at this time, the feature extraction unit 1103 performs the feature extraction after having acquired the trained models corresponding to the executed-task image datasets represented by the information stored on the storage apparatus 13.

The feature comparison unit 1104 calculates degrees of feature similarity on the basis of the features of the inspection-target image dataset extracted by the feature extraction unit 1103 and the features of the executed-task image datasets acquired by the existing feature acquisition unit 1102.

Here, in the learning apparatus 11 according to the first embodiment, the feature comparison unit 1104 calculates degrees of similarity between the overall features of the inspection-target image dataset extracted by the feature extraction unit 1103 and the overall features of the executed-task image datasets acquired by the existing feature acquisition unit 1102.

At this time, for example, the feature comparison unit 1104 may calculate the degrees of similarity between the overall features of the inspection-target image dataset and the overall features of the executed-task image datasets using distribution differences.

In addition, for example, the feature comparison unit 1104 may calculate the degrees of similarity between the overall features of the inspection-target image dataset and the overall features of the executed-task image datasets using common areas of distributions.

On the basis of the degrees of feature similarity calculated by the feature comparison unit 1104, the model selection unit 1105 selects one or more trained models corresponding to executed-task image datasets whose degrees of feature similarity to the inspection-target image dataset acquired by the training image acquisition unit 1101 are high among the executed-task image datasets.

At this time, for example, the model selection unit 1105 selects one or more trained models corresponding to executed-task image datasets in the order of the executed-task image datasets having higher feature similarity to the inspection-target image dataset acquired by the training image acquisition unit 1101, among the executed-task image datasets.

The model learning unit 1106 generates a new trained model by inputting the inspection-target image dataset acquired by the training image acquisition unit 1101 to the trained models selected by the model selection unit 1105 on the basis of the inspection-target image dataset and the trained models. Note that the new trained model generated by the model learning unit 1106 is a good-product distribution.

At this time, for example, the model learning unit 1106 generates the new trained model by inputting a good-product image dataset in the inspection-target image dataset to the trained models selected by the model selection unit 1105, and combining all outputs from the respective intermediate layers.

The model evaluation unit 1107 determines whether the precision of the new trained model generated by the model learning unit 1106 is equal to or higher than a threshold on the basis of the new trained model. Note that the threshold can be set as appropriate to a value for evaluating the trained models.

The model output unit 1108 outputs, to the outside, information representing a new trained model determined as having an evaluation result which is equal to or greater than the threshold on the basis of a result of the determination by the model evaluation unit 1107.

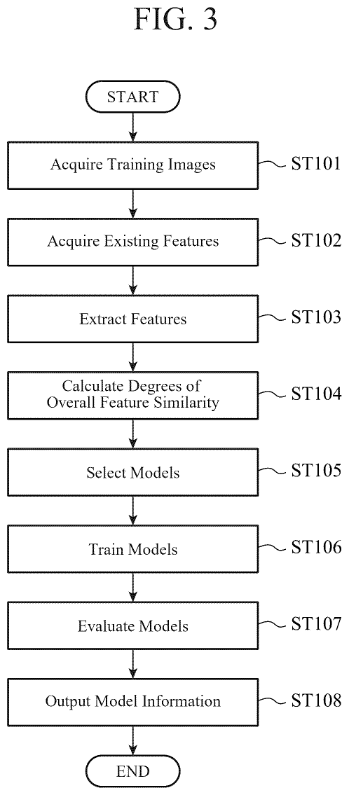

Next, an operation example of the learning apparatus 11 according to the first embodiment illustrated in FIG. 1 and FIG. 2 is explained with reference to FIG. 3 to FIG. 8.

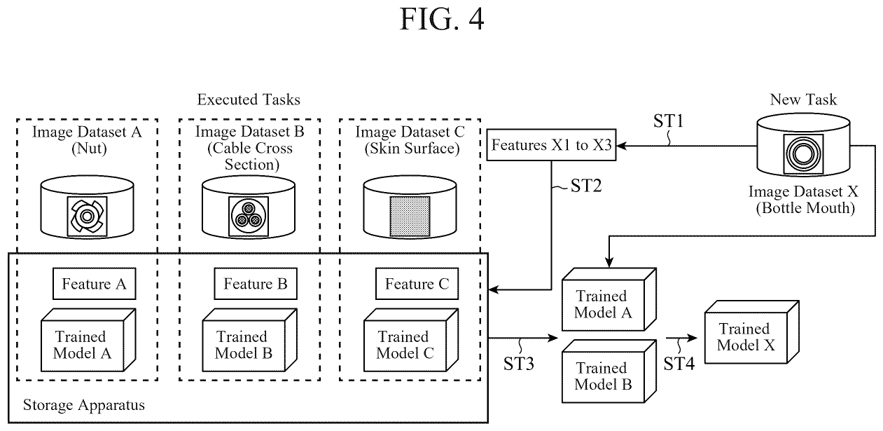

For example, as illustrated in FIG. 4, in the learning apparatus 11 according to the first embodiment, first, features are extracted from an inspection-target (new-task) image dataset (Step ST1). An example in FIG. 4 illustrates a case where the inspection-target image dataset is an image dataset X (bottle mouth), and the features of the image dataset X are features X1 to X3.

In addition, the learning apparatus 11 acquires features of executed-task image datasets (Step ST2). The example in FIG. 4 illustrates a case where the executed-task image datasets are three types of image dataset (an image dataset A (nut), an image dataset B (cable cross section), and an image dataset C (skin surface)). In addition, the executed-task image datasets are associated with features and trained models. In the example in FIG. 4, the image dataset A is associated with a feature A and a trained model A, the image dataset B is associated with a feature B and a trained model B, and the image dataset C is associated with a feature C and a trained model C. Note that information representing the features and the trained models corresponding to the executed-task image datasets are retained in advance in the storage apparatus 13.

Then, the learning apparatus 11 finds image datasets whose features are similar to the inspection-target image dataset from among the executed-task image datasets, and selects the trained models corresponding to the found image datasets (Step ST3). The example in FIG. 4 illustrates a case where the feature A is similar to the feature X1, the feature B is similar to the feature X2, and the learning apparatus 11 selects the trained model A corresponding to the image dataset A and the trained model B corresponding to the image dataset B.

Then, the learning apparatus 11 generates a new trained model (good-product distribution) on the basis the selected trained models (Step ST4). The example in FIG. 4 illustrates a case where the learning apparatus 11 generates a new trained model X on the basis of the selected trained model A and trained model B.

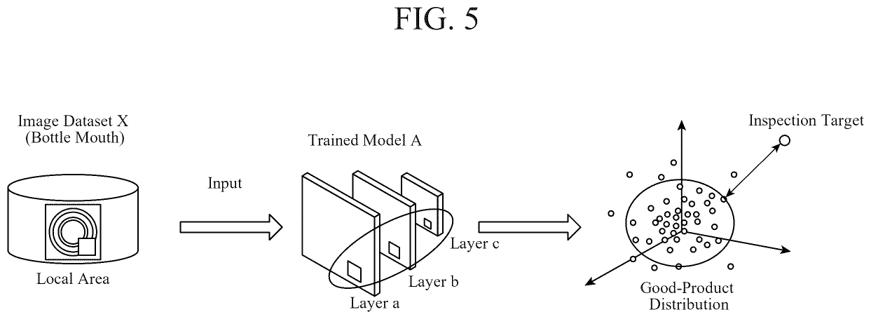

In addition, for example, as illustrated in FIG. 5, it is premised that, in the learning apparatus 11 according to the first embodiment, feature extraction is performed using a plurality of intermediate layers among intermediate layers of the trained models, and a new trained model (good-product distribution) is generated. An example in FIG. 5 illustrates a case where the plurality of intermediate layers are three layer (a layer a, a layer b, and a layer c).

In this case, the learning apparatus 11 according to the first embodiment uses past models (the trained models corresponding to the executed-task image datasets), and performs feature extraction. In addition, considering the premise of generating a good-product distribution, it is desirable to use a plurality of intermediate layers useful for feature extraction from the past models.

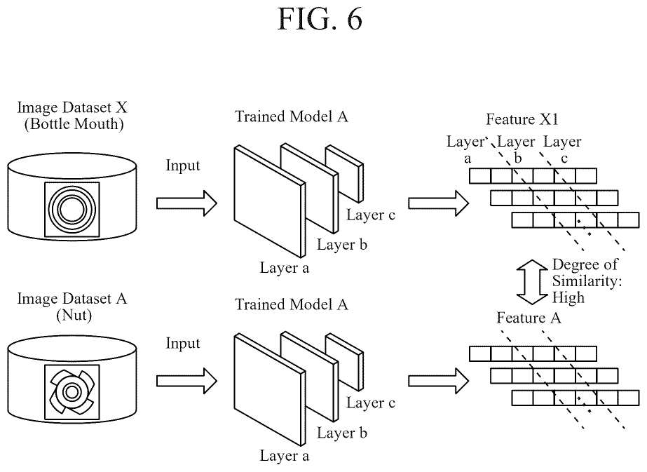

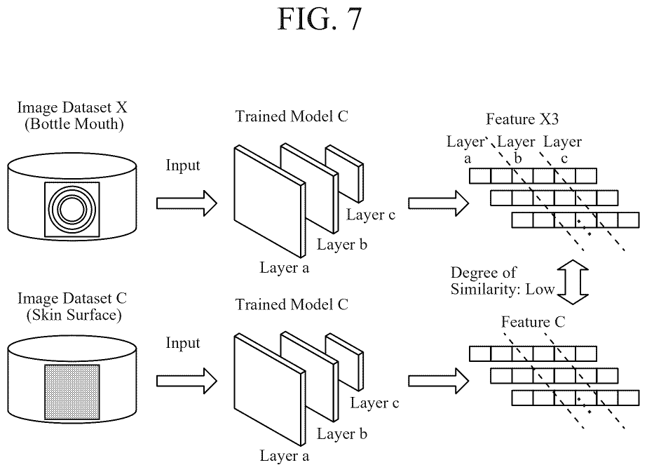

In view of this, for example, as illustrated in FIG. 6 and FIG. 7, in the learning apparatus 11 according to the first embodiment, one or more past models whose degrees of overall feature similarity are high are selected using features based on outputs from the plurality of intermediate layers. An example in FIG. 6 illustrates a case where the learning apparatus 11 compares the feature X1 of the image dataset X with the feature A of the image dataset A. In this case, the learning apparatus 11 extracts the feature X1 by inputting the image dataset X to the trained model A corresponding to the image dataset A. Note that the example in FIG. 6 illustrates a case where the degree of similarity between the feature X1 and the feature A is high. In addition, an example in FIG. 7 illustrates a case where the learning apparatus 11 compares the feature X3 of the image dataset 0025X with the feature C of the image dataset C. In this case, the learning apparatus 11 extracts the feature X3 by inputting the image dataset X to the trained model C corresponding to the image dataset C. Note that the example in FIG. 7 illustrates a case where the degree of similarity between the feature X3 and the feature C is low.

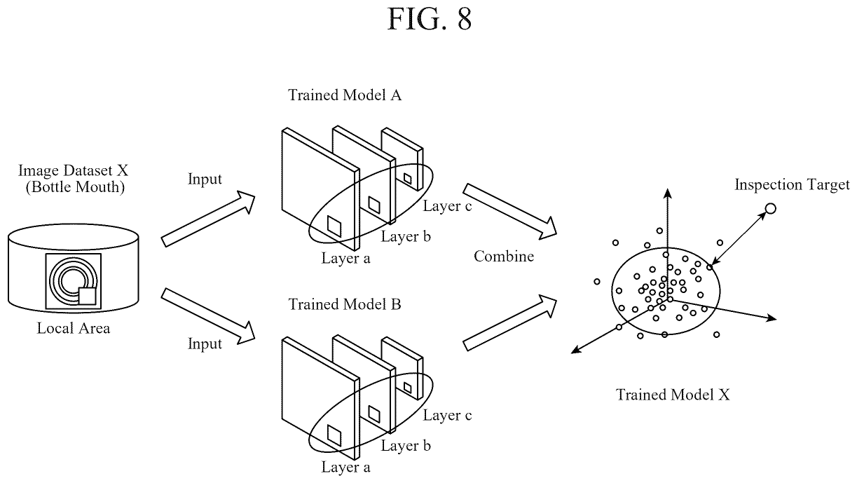

Then, for example, as illustrated in FIG. 8, the learning apparatus 11 generates the new trained model by inputting the inspection-target image dataset to the selected past models, and combining all outputs from the respective intermediate layers. An example in FIG. 8 illustrates a case where the learning apparatus 11 selects the trained model A and the trained model B, and generates the new trained model X.

In an operation example of the learning apparatus 11 according to the first embodiment illustrated in FIG. 1 and FIG. 2, for example, as illustrated in FIG. 3, first, the training image acquisition unit 1101 acquires an inspection-target image dataset (Step ST101). At this time, the training image acquisition unit 1101 acquires an inspection-target image dataset input via the operation input apparatus 12.

In the examples in FIG. 4 to FIG. 8, the training image acquisition unit 1101 acquires the image dataset X.

In addition, the existing feature acquisition unit 1102 acquires features of executed-task image datasets (Step ST102). At this time, the existing feature acquisition unit 1102 acquires the features of the executed-task image datasets represented by the information stored on the storage apparatus 13. In addition, the features of the executed-task image datasets acquired by the existing feature acquisition unit 1102 are features based on outputs from a plurality of intermediate layers in the trained models corresponding to the executed-task image datasets.

In the examples in FIG. 4 to FIG. 8, the existing feature acquisition unit 1102 acquires the feature A of the image dataset A, the feature B of the image dataset B, and the feature C of the image dataset C. Note that, in the examples in FIG. 6 and FIG. 7, features acquired by the existing feature acquisition unit 1102 are features based on outputs from the layer a, the layer b, and the layer c of the past models.

Next, the feature extraction unit 1103 extracts features of the inspection-target image dataset acquired by the training image acquisition unit 1101 on the basis of the trained models corresponding to the executed-task image datasets and the inspection-target image dataset (Step ST103). The features of the inspection-target image dataset extracted by the feature extraction unit 1103 are features based on outputs from the plurality of intermediate layers in the trained models.

At this time, for example, the feature extraction unit 1103 may extract, as features, outputs from the plurality of intermediate layers that are obtained when the inspection-target image dataset or a good-product image dataset in the inspection-target image dataset is input to the trained models corresponding to the executed-task image datasets.

In addition, for example, the feature extraction unit 1103 may extract, as features, vector groups obtained by averaging, channel by channel, outputs from the plurality of intermediate layers obtained when the inspection-target image dataset or a good-product image dataset in the inspection-target image dataset is input to the trained models corresponding to the executed-task image datasets.

In addition, for example, the feature extraction unit 1103 may extract, as features, vectors obtained by averaging the overall outputs from the plurality of intermediate layers obtained when the inspection-target image dataset or a good-product image dataset in the inspection-target image dataset is input to the trained models corresponding to the executed-task image datasets.

Note that, at this time, the feature extraction unit 1103 performs the feature extraction after having acquired the trained models corresponding to the executed-task image datasets represented by the information stored on the storage apparatus 13.

In the examples in FIG. 4 to FIG. 8, the feature extraction unit 1103 extracts the features X1 to X3. The feature X1 is a feature extracted by inputting the image dataset X to the trained model A. In addition, the feature X2 is a feature extracted by inputting the image dataset X to the trained model B. In addition, the feature X3 is a feature extracted by inputting the image dataset X to the trained model C. Note that, in the examples in FIG. 6 and FIG. 7, features extracted by the feature extraction unit 1103 are features based on outputs from the layer a, the layer b, and the layer c of the past models.

Next, the feature comparison unit 1104 calculates degrees of feature similarity on the basis of the features of the inspection-target image dataset extracted by the feature extraction unit 1103 and the features of the executed-task image datasets acquired by the existing feature acquisition unit 1102 (Step ST104).

Here, in the learning apparatus 11 according to the first embodiment, the feature comparison unit 1104 calculates degrees of similarity between the overall features of the inspection-target image dataset extracted by the feature extraction unit 1103 and the overall features of the executed-task image datasets acquired by the existing feature acquisition unit 1102.

At this time, for example, the feature comparison unit 1104 may calculate the degrees of similarity between the overall features of the inspection-target image dataset and the overall features of the executed-task image datasets using distribution differences. At this time, as the distribution differences, for example, the feature comparison unit 1104 can adopt the Frechet inception distance, the KL divergence, the JS divergence, or the Mahalanobis distance.

In addition, for example, the feature comparison unit 1104 may calculate the degrees of similarity between the overall features of the inspection-target image dataset and the overall features of the executed-task image datasets using common areas of distributions. At this time, as the common areas of distributions, for example, the feature comparison unit 1104 can adopt the Histogram intersection.

Next, on the basis of the degrees of feature similarity calculated by the feature comparison unit 1104, the model selection unit 1105 selects one or more trained models corresponding to executed-task image datasets whose degrees of feature similarity to the inspection-target image dataset acquired by the training image acquisition unit 1101 among the executed-task image datasets (Step ST105).

At this time, for example, the model selection unit 1105 selects one or more trained models corresponding to executed-task image datasets in the order of the executed-task image datasets having higher feature similarity to the inspection-target image dataset acquired by the training image acquisition unit 1101, among the executed-task image datasets.

In the examples in FIG. 4 to FIG. 8, the degrees of similarity between the feature X1 (overall features across the layer a, the layer b, and the layer c) and the feature A (overall features across the layer a, the layer b, and the layer c), and between the feature X2 (overall features across the layer a, the layer b, and the layer c) and the feature B (overall features across the layer a, the layer b, and the layer c) are high, and the feature extraction unit 1103 selects the trained model A and the trained model B.

On the other hand, in the examples in FIG. 4 to FIG. 8, the degree of similarity between the feature X3 (overall features across the layer a, the layer b, and the layer c) and the feature C (overall features across the layer a, the layer b, and the layer c) is low, and the feature extraction unit 1103 does not select the trained model C.

Next, the model learning unit 1106 generates a new trained model by inputting the inspection-target image dataset acquired by the training image acquisition unit 1101 to the trained models selected by the model selection unit 1105 on the basis of the inspection-target image dataset and the trained models (Step ST106). Note that the new trained model generated by the model learning unit 1106 is a good-product distribution.

At this time, for example, the model learning unit 1106 generates the new trained model by inputting a good-product image dataset in the inspection-target image dataset to the trained models selected by the model selection unit 1105, and combining all outputs from the respective intermediate layers.

In the examples in FIG. 4 to FIG. 8, the model learning unit 1106 generates the new trained model X from the trained model A and the trained model B. At this time, the model learning unit 1106 generates the new trained model X (good-product distribution) by inputting the image dataset X to each of the trained model A and the trained model B, and combining all outputs from the intermediate layers (the layer a, the layer b, and the layer c) of the trained model A and all outputs from the intermediate layers (the layer a, the layer b, and the layer c) of the trained model B.

Next, the model evaluation unit 1107 determines whether the precision of the new trained model generated by the model learning unit 1106 is equal to or higher than a threshold on the basis of the new trained model (Step ST107). Note that the threshold can be set as appropriate to a value for evaluating the trained models.

Next, the model output unit 1108 outputs, to the outside, information representing a new trained model determined as having an evaluation result which is equal to or greater than the threshold on the basis of a result of the determination by the model evaluation unit 1107 (Step ST108).

Here, in conventional technologies, there is a possibility that a trained model appropriate for an inspection-target image dataset cannot be selected in selection of a plurality of past models.

In contrast to this, in the learning apparatus 11 according to the first embodiment, by comparing features of an inspection-target image dataset (features based on model intermediate outputs) with features of executed-task image datasets (features based on model intermediate outputs), trained models can be selected on the basis of data similar to the inspection-target image dataset, taking into consideration that a new trained model for anomaly detection is generated, which can be expected to improve precision.

As mentioned above, according to the first embodiment, the learning apparatus 11 includes: the training image acquisition unit 1101 to acquire an inspection-target image dataset; the existing feature acquisition unit 1102 to acquire features of executed-task image datasets, the features being based on outputs from a plurality of intermediate layers in trained models corresponding to the executed-task image datasets; the feature extraction unit 1103 to extract features of the inspection-target image dataset acquired by the training image acquisition unit 1101 on the basis of the trained models corresponding to the executed-task image datasets and the inspection-target image dataset, the features being based on outputs from the plurality of intermediate layers in the trained models; the feature comparison unit 1104 to calculate degrees of feature similarity on the basis of the features of the inspection-target image dataset extracted by the feature extraction unit 1103 and the features of the executed-task image datasets acquired by the existing feature acquisition unit 1102; the model selection unit 1105 to select, on the basis of the degrees of feature similarity calculated by the feature comparison unit 1104, one or more trained models corresponding to executed-task image datasets whose degrees of feature similarity to the inspection-target image dataset acquired by the training image acquisition unit 1101 are high among the executed-task image datasets; the model learning unit 1106 to generate a new trained model which is a good-product distribution by inputting the inspection-target image dataset acquired by the training image acquisition unit 1101 to the trained models selected by the model selection unit 1105 on the basis of the inspection-target image dataset and the trained models; the model evaluation unit 1107 to determine whether an evaluation result of the new trained model generated by the model learning unit 1106 is equal to or higher than a threshold on the basis of the new trained model; and the model output unit 1108 to output information representing a new trained model determined as having an evaluation result which is equal to or greater than the threshold on the basis of a result of the determination by the model evaluation unit 1107. In particular, in the learning apparatus 11 according to the first embodiment, the feature comparison unit 1104 calculates degrees of similarity between the overall features of the inspection-target image dataset extracted by the feature extraction unit 1103 and the overall features of the executed-task image datasets acquired by the existing feature acquisition unit 1102, and selects a trained model.

Thereby, the learning apparatus 11 according to the first embodiment makes it possible to obtain a trained model appropriate for an inspection-target image dataset as compared to conventional techniques.

### Second Embodiment

In the case illustrated, in the learning apparatus 11 according to the first embodiment, the degrees of similarity between overall features of an inspection-target image dataset and overall features of executed-task image datasets are calculated, and a trained model is selected. In contrast to this, in a case to be illustrated, in a learning apparatus 11 according to a second embodiment, the degree of similarity between a feature of each intermediate layer of an inspection-target image dataset and a feature of a corresponding intermediate layer of executed-task image datasets is calculated, and a trained model (intermediate layer) is selected.

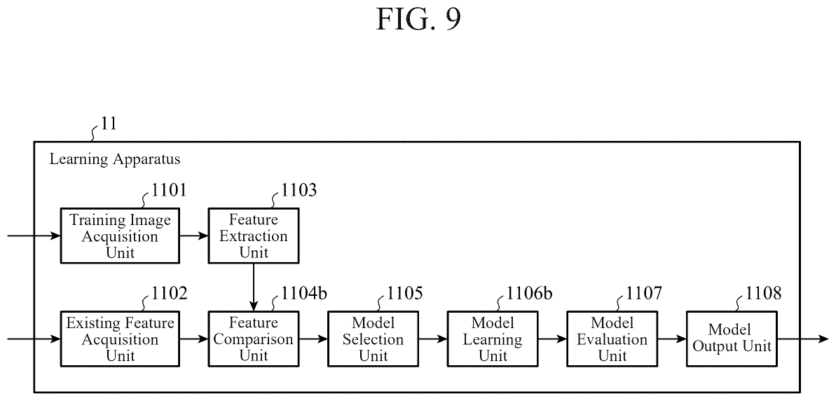

FIG. 9 is a diagram illustrating a configuration example of the learning apparatus 11 according to the second embodiment. The learning apparatus 11 according to the second embodiment illustrated in FIG. 9 is obtained by changing the feature comparison unit 1104 and the model learning unit 1106 in the learning apparatus 11 according to the first embodiment illustrated in FIG. 2 to a feature comparison unit 1104b and a model learning unit 1106b, respectively. Other configuration examples in the learning apparatus 11 according to the second embodiment illustrated in FIG. 9 are similar to the configuration examples of the learning apparatus 11 according to the first embodiment illustrated in FIG. 2, and are given the same reference signs, and only differences are explained.

The feature comparison unit 1104b calculates degrees of feature similarity on the basis of features of an inspection-target image dataset extracted by a feature extraction unit 1103 and features of executed-task image datasets acquired by an existing feature acquisition unit 1102.

Here, in the learning apparatus 11 according to the second embodiment, the feature comparison unit 1104b calculates the degree of similarity between a feature of each intermediate layer of the inspection-target image dataset extracted by the feature extraction unit 1103 and the overall features of a corresponding intermediate layer of the executed-task image datasets acquired by the existing feature acquisition unit 1102.

At this time, for example, the feature comparison unit 1104b may calculate the degree of similarity between a feature of each intermediate layer of the inspection-target image dataset and a feature of a corresponding intermediate layer of the executed-task image datasets using distribution differences.

In addition, for example, the feature comparison unit 1104b may calculate the degree of similarity between a feature on each layer of the intermediate layers of the inspection-target image dataset and a feature on a corresponding layer of the intermediate layers of the executed-task image datasets using common areas of distributions.

The model learning unit 1106b generates a new trained model by inputting the inspection-target image dataset acquired by a training image acquisition unit 1101 to the trained models selected by a model selection unit 1105 on the basis of the inspection-target image dataset and the trained models. Note that the new trained model generated by the model learning unit 1106b is a good-product distribution.

At this time, for example, the model learning unit 1106b generates the new trained model by inputting a good-product image dataset in the inspection-target image dataset to the trained models selected by the model selection unit 1105, and selectively combining tensors from among outputs from the respective intermediate layers.

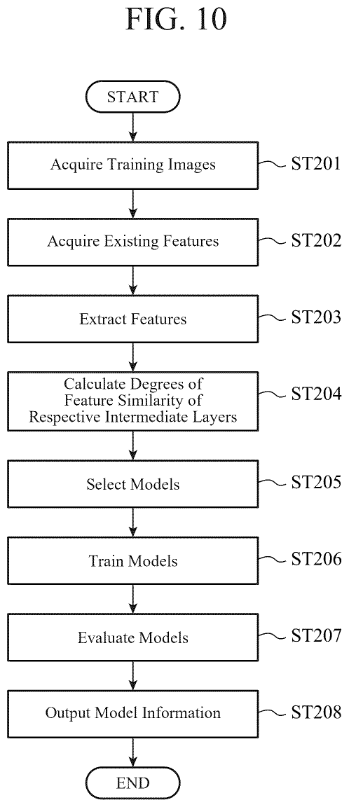

Next, an operation example of the learning apparatus 11 according to the second embodiment illustrated in FIG. 1 and FIG. 9 is explained with reference to FIG. 10 to FIG. 13.

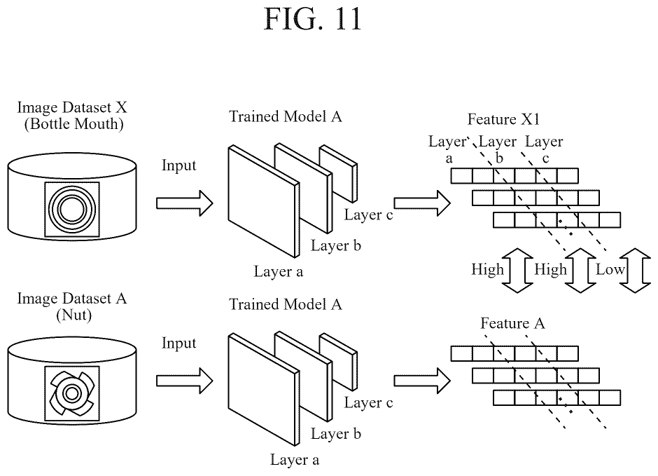

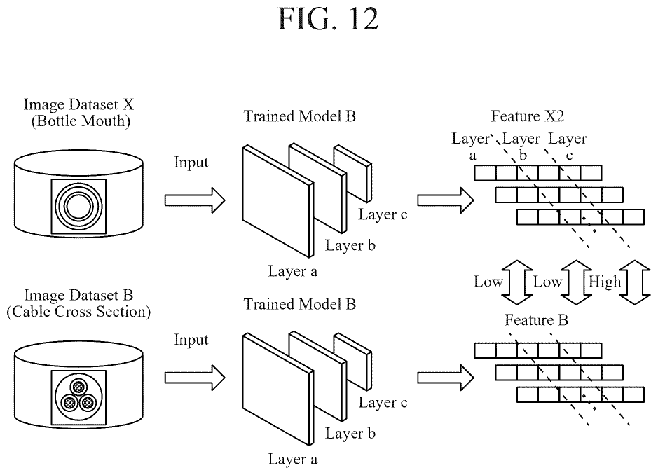

For example, as illustrated in FIG. 11 and FIG. 12, in the learning apparatus 11 according to the second embodiment, one or more past models whose degrees of feature similarity of the respective intermediate layers are high are selected using features based on outputs from the plurality of intermediate layers. An example in FIG. 11 illustrates a case where the learning apparatus 11 compares a feature X1 of an image dataset X with a feature A of an image dataset A. In this case, the learning apparatus 11 extracts the feature X1 by inputting the image dataset X to a trained model A corresponding to the image dataset A. Note that the example in FIG. 11 illustrates a case where the degree of similarity between the feature X1 and the feature A is high with respect to the layer a and the layer b. In addition, an example in FIG. 12 illustrates a case where the learning apparatus 11 compares a feature X2 of the image dataset X with a feature B of an image dataset B. In this case, the learning apparatus 11 extracts the feature X2 by inputting the image dataset X to a trained model B corresponding to the image dataset B. Note that the example in FIG. 12 illustrates a case where the degree of similarity between the feature X2 and the feature B is high with respect to the layer c.

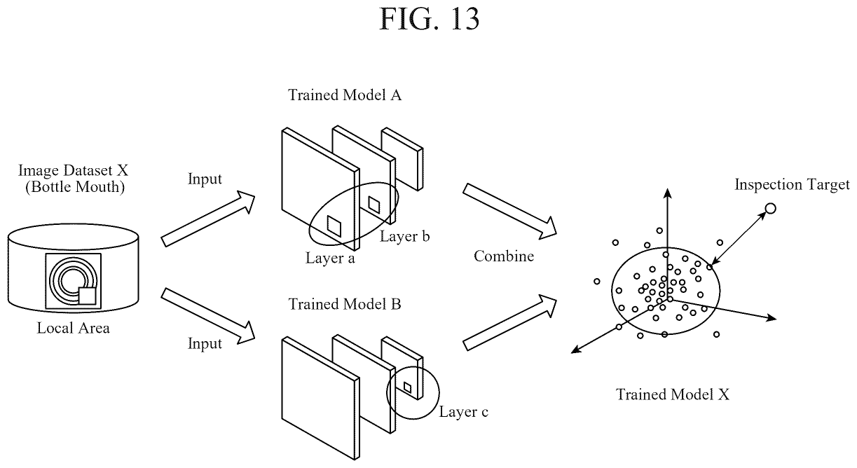

Then, for example, as illustrated in FIG. 13, the learning apparatus 11 generates a new trained model by inputting the inspection-target image dataset to the selected past models, and selectively combining tensors from among outputs from the respective intermediate layers. An example in FIG. 13 illustrates a case where the learning apparatus 11 selects the trained model A (the layer a and the layer b) and the trained model B (the layer c), and generates a new trained model X.

In an operation example of the learning apparatus 11 according to the second embodiment illustrated in FIG. 1 and FIG. 9, for example, as illustrated in FIG. 10, first, the training image acquisition unit 1101 acquires an inspection-target image dataset (Step ST201). At this time, the training image acquisition unit 1101 acquires an inspection-target image dataset input via an operation input apparatus 12.

In the examples in FIG. 4, FIG. 5 and FIG. 11 to FIG. 13, the training image acquisition unit 1101 acquires the image dataset X.

In addition, the existing feature acquisition unit 1102 acquires features of executed-task image datasets (Step ST202). At this time, the existing feature acquisition unit 1102 acquires features of executed-task image datasets represented by information stored on a storage apparatus 13. In addition, the features of the executed-task image datasets acquired by the existing feature acquisition unit 1102 are features based on outputs from a plurality of intermediate layers in the trained models corresponding to the executed-task image datasets.

In the examples in FIG. 4, FIG. 5, and FIG. 11 to FIG. 13, the existing feature acquisition unit 1102 acquires the feature A of the image dataset A, the feature B of the image dataset B, and a feature C of an image dataset C. Note that, in the examples in FIG. 11 and FIG. 12, features acquired by the existing feature acquisition unit 1102 are features based on outputs from the layer a, the layer b, and the layer c of the past models.

Next, the feature extraction unit 1103 extracts features of the inspection-target image dataset acquired by the training image acquisition unit 1101 on the basis of the trained models corresponding to the executed-task image datasets and the inspection-target image dataset (Step ST203). The features of the inspection-target image dataset extracted by the feature extraction unit 1103 are features based on outputs from the plurality of intermediate layers in the trained models.

At this time, for example, the feature extraction unit 1103 may extract, as features, outputs from the plurality of intermediate layers that are obtained when the inspection-target image dataset or a good-product image dataset in the inspection-target image dataset is input to the trained models corresponding to the executed-task image datasets.

In addition, for example, the feature extraction unit 1103 may extract, as features, vector groups obtained by averaging, channel by channel, outputs from the plurality of intermediate layers obtained when the inspection-target image dataset or a good-product image dataset in the inspection-target image dataset is input to the trained models corresponding to the executed-task image datasets.

In addition, for example, the feature extraction unit 1103 may extract, as features, vectors obtained by averaging the overall outputs from the plurality of intermediate layers obtained when the inspection-target image dataset or a good-product image dataset in the inspection-target image dataset is input to the trained models corresponding to the executed-task image datasets.

Note that, at this time, the feature extraction unit 1103 performs the feature extraction after having acquired the trained models corresponding to the executed-task image datasets represented by the information stored on the storage apparatus 13.

In the examples in FIG. 4, FIG. 5, and FIG. 11 to FIG. 13, the feature extraction unit 1103 extracts the features X1 to X3. The feature X1 is a feature extracted by inputting the image dataset X to the trained model A. In addition, the feature X2 is a feature extracted by inputting the image dataset X to the trained model B. In addition, the feature X3 is a feature extracted by inputting the image dataset X to a trained model C. Note that, in the examples in FIG. 11 and FIG. 12, features extracted by the feature extraction unit 1103 are features based on outputs from the layer a, the layer b, and the layer c of the past models.

Next, the feature comparison unit 1104b calculates degrees of feature similarity on the basis of the features of the inspection-target image dataset extracted by the feature extraction unit 1103 and the features of the executed-task image datasets acquired by the existing feature acquisition unit 1102 (Step ST204).

Here, in the learning apparatus 11 according to the second embodiment, the feature comparison unit 1104b calculates the degree of similarity between a feature of each intermediate layer of the inspection-target image dataset extracted by the feature extraction unit 1103 and a feature of a corresponding intermediate layer of the executed-task image datasets acquired by the existing feature acquisition unit 1102.

At this time, for example, the feature comparison unit 1104b may calculate the degree of similarity between a feature of each intermediate layer of the inspection-target image dataset and a feature of a corresponding intermediate layer of the executed-task image datasets using distribution differences. At this time, as the distribution differences, for example, the feature comparison unit 1104b can adopt the Frechet inception distance, the KL divergence, the JS divergence, or the Mahalanobis distance.

In addition, for example, the feature comparison unit 1104b may calculate the degree of similarity between a feature of each intermediate layer of the inspection-target image dataset and a feature of a corresponding intermediate layer of the executed-task image datasets using common areas of distributions. At this time, as the common areas of distributions, for example, the feature comparison unit 1104b can adopt the Histogram intersection.

Next, on the basis of the degrees of feature similarity calculated by the feature comparison unit 1104b, the model selection unit 1105 selects one or more trained models corresponding to executed-task image datasets whose degrees of feature similarity to the inspection-target image dataset acquired by the training image acquisition unit 1101 are high among the executed-task image datasets (Step ST205).

At this time, for example, the model selection unit 1105 selects one or more trained models corresponding to executed-task image datasets in the order of the executed-task image datasets having higher feature similarity to the inspection-target image dataset acquired by the training image acquisition unit 1101, among the executed-task image datasets.

In the examples in FIG. 4, FIG. 5, and FIG. 11 to FIG. 13, the degrees of similarity between the feature X1 and the feature A with respect to the layer a and the layer b and the feature X2 and the feature B with respect to the layer c are high, and the feature extraction unit 1103 selects the trained model A and the trained model B.

On the other hand, in the examples in FIG. 4, FIG. 5, and FIG. 11 to FIG. 13, the degree of similarity between the feature X3 and the feature C with respect to the layer a, the layer b, and the layer c is low, and the feature extraction unit 1103 does not select the trained model C.

Next, the model learning unit 1106b generates a new trained model by inputting the inspection-target image dataset acquired by the training image acquisition unit 1101 to the trained models selected by the model selection unit 1105 on the basis of the inspection-target image dataset and the trained models (Step ST206). Note that the new trained model generated by the model learning unit 1106b is a good-product distribution.

At this time, for example, the model learning unit 1106b generates the new trained model by inputting a good-product image dataset in the inspection-target image dataset to the trained models selected by the model selection unit 1105, and selectively combining tensors from among outputs from the respective intermediate layers.

In the examples in FIG. 4, FIG. 5, and FIG. 11 to FIG. 13, the model learning unit 1106b generates the new trained model X from the trained model A and the trained model B. At this time, the model learning unit 1106 generates the new trained model X (good-product distribution) by inputting the image dataset X to each of the trained model A and the trained model B, and combining outputs from the intermediate layers (the layer a and the layer b) of the trained model A, where the degree of similarity is high, and outputs from the intermediate layer (the layer c) of the trained model B, where the degree of similarity is high.

Next, a model evaluation unit 1107 determines whether the precision of the new trained model generated by the model learning unit 1106b is equal to or higher than a threshold on the basis of the new trained model (Step ST207). Note that the threshold can be set as appropriate to a value for evaluating the trained models.

Next, the model output unit 1108 outputs, to the outside, information representing a new trained model determined as having an evaluation result which is equal to or greater than the threshold on the basis of a result of the determination by the model evaluation unit 1107 (Step ST208).

Here, in conventional technologies, there is a possibility that a trained model appropriate for an inspection-target image dataset cannot be selected in selection of a plurality of past models.

In contrast to this, in the learning apparatus 11 according to the second embodiment, by comparing features of an inspection-target image dataset (features based on model intermediate outputs) with features of executed-task image datasets (features based on model intermediate outputs), trained models (intermediate layers) can be selected on the basis of data similar to the inspection-target image dataset, taking into consideration that a new trained model for anomaly detection is generated, which can be expected to improve precision.

As mentioned above, in the learning apparatus 11 according to the second embodiment, the feature comparison unit 1104 calculates the degree of similarity between a feature of each intermediate layer of the inspection-target image dataset extracted by the feature extraction unit 1103 and a feature of a corresponding intermediate layer of the executed-task image datasets acquired by the existing feature acquisition unit 1102, and selects trained models (intermediate layers). Thereby, the learning apparatus 11 according to the second embodiment makes it possible to obtain a trained model appropriate for new data as compared to conventional techniques.

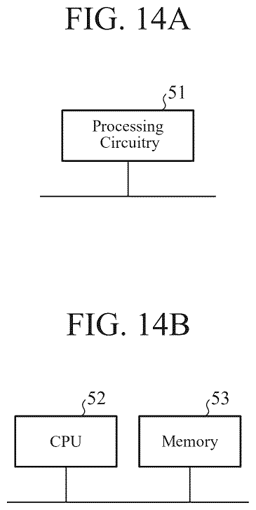

Last, hardware configuration examples of the learning apparatus 11 according to the first and second embodiments are explained with reference to FIGS. 14A and 14B. Although the hardware configuration examples of the learning apparatus 11 according to the first embodiment are explained here, the same applies also to hardware configuration examples of the learning apparatus 11 according to the second embodiment.

Respective functions of the training image acquisition unit 1101, the existing feature acquisition unit 1102, the feature extraction unit 1103, the feature comparison unit 1104, the model selection unit 1105, the model learning unit 1106, the model evaluation unit 1107, and the model output unit 1108 in the learning apparatus 11 are implemented by processing circuitry 51. The processing circuitry 51 may be dedicated hardware as illustrated in FIG. 14A, or may be a Central Processing Unit (CPU; also referred to as a central processor, a processing unit, a computing apparatus, a microprocessor, a microcomputer, a processor, or a Digital Signal Processor (DSP)) 52 to execute programs stored on a memory 53 as illustrated in FIG. 14B.

In a case where the processing circuitry 51 is dedicated hardware, for example, the processing circuitry 51 is a single circuit, a composite circuit, a programmed processor, a parallel-programmed processor, an Application Specific Integrated Circuit (ASIC), a Field Programmable Gate Array (FPGA), or a combination of these. Respective functions of each of the training image acquisition unit 1101, the existing feature acquisition unit 1102, the feature extraction unit 1103, the feature comparison unit 1104, the model selection unit 1105, the model learning unit 1106, the model evaluation unit 1107, and the model output unit 1108 may be implemented by the processing circuitry 51, and the functions of the respective units may be collectively implemented by the processing circuitry 51.

In a case where the processing circuitry 51 is the CPU 52, the functions of the training image acquisition unit 1101, the existing feature acquisition unit 1102, the feature extraction unit 1103, the feature comparison unit 1104, the model selection unit 1105, the model learning unit 1106, the model evaluation unit 1107, and the model output unit 1108 are implemented by software, firmware, or a combination of software and firmware. Software and firmware are written as programs, and stored on the memory 53. The processing circuitry 51 implements the functions of each unit by reading out and executing the programs stored on the memory 53. That is, the learning apparatus 11 includes the memory 53 for storing the programs, execution of which by the processing circuitry 51 results in execution of each step illustrated in FIG. 3, for example. In addition, these programs can also be said to be programs for causing a computer to execute procedures and methods performed by the training image acquisition unit 1101, the existing feature acquisition unit 1102, the feature extraction unit 1103, the feature comparison unit 1104, the model selection unit 1105, the model learning unit 1106, the model evaluation unit 1107, and the model output unit 1108.

Here, for example, the memory 53 is a non-volatile or volatile semiconductor memory such as a Random Access Memory (RAM), a Read Only Memory (ROM), a flash memory, an Erasable Programmable ROM (EPROM), or an Electrically EPROM (EEPROM), a magnetic disk, a flexible disc, an optical disc, a compact disc, a mini disc, a Digital Versatile Disc (DVD), or the like.

Note that some of the respective functions of the training image acquisition unit 1101, the existing feature acquisition unit 1102, the feature extraction unit 1103, the feature comparison unit 1104, the model selection unit 1105, the model learning unit 1106, the model evaluation unit 1107, and the model output unit 1108 may be implemented by dedicated hardware, and some of them may be implemented by software or firmware. For example, it is possible to implement the functions of the training image acquisition unit 1101 using the processing circuitry 51 as dedicated hardware, and implement the functions of the existing feature acquisition unit 1102, the feature extraction unit 1103, the feature comparison unit 1104, the model selection unit 1105, the model learning unit 1106, the model evaluation unit 1107, and the model output unit 1108 by causing the processing circuitry 51 to read out and execute programs stored on the memory 53.

In this manner, the processing circuitry 51 can implement the respective functions mentioned above by hardware, software, firmware, or a combination of these.

Note that any combination of respective embodiments, modifications of any components in each embodiment, or omissions of any components in each embodiment are possible.

### INDUSTRIAL APPLICABILITY

The learning apparatus according to the present disclosure makes it possible to obtain a trained model appropriate for an inspection-target image dataset as compared to conventional techniques, and is suited for being used as a learning apparatus that obtains a trained model or the like.

### REFERENCE SIGNS LIST

1: Learning system; 11: Learning apparatus; 12: Operation input apparatus; 13: rage apparatus; 14: Display output apparatus; 51: Processing circuitry; 52: CPU; 53: Memory; 1101: Training image acquisition unit; 1102: Existing feature acquisition unit; 1103: Feature extraction unit; 1104, 1104b: Feature comparison unit; 1105: Model selection unit; 1106, 1106b: Model learning unit; 1107: Model evaluation unit; 1108: Model output unit

1. A learning apparatus comprising:
processing circuitry configured to
acquire an inspection-target image dataset;
acquire features of executed-task image datasets, the features being based on outputs from a plurality of intermediate layers in trained models corresponding to the executed-task image datasets;
extract features of the acquired inspection-target image dataset a basis of the trained models corresponding to the executed-task image datasets and the inspection-target image dataset, the features being based on outputs from the plurality of intermediate layers in the trained models;
calculate degrees of feature similarity on a basis of the features of the extracted inspection-target image dataset and the features of the executed-task image datasets having been acquired;
select, on a basis of the degrees of feature similarity having been calculated, one or more trained models corresponding to executed-task image datasets whose degrees of feature similarity to the acquired inspection-target image dataset are high in the executed-task image datasets;
generate a new trained model which is a good-product distribution by inputting the acquired inspection-target image dataset to the selected trained models on a basis of the acquired inspection-target image dataset and the selected trained models;
determine whether precision of the generated new trained model is equal to or higher than a threshold on a basis of the generated new trained model; and
output information representing the new trained model determined as having precision which is equal to or greater than the threshold on a basis of a result of the determination.

2. The learning apparatus according to claim 1, wherein
the processing circuitry is further configured to
extract, as features, outputs from the plurality of intermediate layers obtained when the acquired inspection-target image dataset or a good-product image dataset in the inspection-target image dataset is input to the trained models corresponding to the executed-task image datasets.

3. The learning apparatus according to claim 1, wherein the processing circuitry is further configured to extract, as features, vector groups obtained by averaging, channel by channel, outputs from the plurality of intermediate layers obtained when the acquired inspection-target image dataset or a good-product image dataset in the inspection-target image dataset is input to the trained models corresponding to the executed-task image datasets.

4. The learning apparatus according to claim 1, wherein the processing circuitry is further configured to extract, as features, vectors obtained by averaging the overall outputs from the plurality of intermediate layers obtained when the acquired inspection-target image dataset or a good-product image dataset in the inspection-target image dataset is input to the trained models corresponding to the executed-task image datasets.

5. The learning apparatus according to claim 2, wherein the processing circuitry is further configured to calculate degrees of similarity between the overall features of the extracted inspection-target image dataset and the overall features of the executed-task image datasets having been acquired using distribution differences.

6. The learning apparatus according to claim 4, wherein the processing circuitry is further configured to calculate degrees of similarity between the overall features of the inspection-target image dataset having been extracted and the overall features of the executed-task image datasets having been acquired using common areas of distributions.

7. The learning apparatus according to claim 2, wherein the processing circuitry is further configured to calculate a degree of similarity between a feature on each layer of the intermediate layers of the inspection-target image dataset having been extracted and a feature on a corresponding layer of the intermediate layers of the executed-task image datasets having been acquired using distribution differences.

8. The learning apparatus according to claim 4, wherein the processing circuitry is further configured to calculate a degree of similarity between a feature on each layer of the intermediate layers of the inspection-target image dataset having been extracted and a feature on a corresponding layer of the intermediate layers of the executed-task image datasets having been acquired using common areas of distributions.

9. The learning apparatus according to claim 1, wherein the processing circuitry is further configured to generate a new trained model which is a good-product distribution by inputting a good-product image dataset in the acquired inspection-target image dataset to the selected trained models, and combining all outputs from the respective intermediate layers.

10. The learning apparatus according to claim 1, wherein the processing circuitry is further configured to generate a new trained model which is a good-product distribution by inputting a good-product image dataset in the acquired inspection-target image dataset to the selected trained models, and selectively combining tensors from among outputs from the respective intermediate layers.

11. A learning method comprising:
acquiring an inspection-target image dataset;
acquiring features of executed-task image datasets, the features being based on outputs from a plurality of intermediate layers in trained models corresponding to the executed-task image datasets;
extracting features of the acquired inspection-target image dataset on a basis of the trained models corresponding to the executed-task image datasets and the inspection-target image dataset, the features being based on outputs from the plurality of intermediate layers in the trained models;
calculating degrees of feature similarity on a basis of the features of the extracted inspection-target image dataset and the features of the executed-task image datasets having been acquired;
selecting, on a basis of the degrees of feature similarity having been calculated, one or more trained models corresponding to executed-task image datasets whose degrees of feature similarity to the acquired inspection-target image dataset are high in the executed-task image datasets;
generating a new trained model which is a good-product distribution by inputting the acquired inspection-target image dataset to the selected trained models on a basis of the acquired inspection-target image dataset and the selected trained models;
determining whether an evaluation result of the generated new trained model is equal to or higher than a threshold on a basis of the generated new trained model; and
outputting information representing the new trained model determined as having an evaluation result which is equal to or greater than the threshold on a basis of a result of the determination.
